(19) United States
(12) Patent Application Publication
(10) Pub. No.: US 2013/0073113 A1
(43) Pub. Date: Mar. 21, 2013

(54) VEHICLE AND METHOD FOR ESTIMATING A RANGE FOR THE VEHICLE

(71) Applicants: Qing Wang, Canton, MI (US); Hai Yu, Canton, MI (US); William Paul Perkins, Dearborn, MI (US); Anthony Mark Phillips, Northville, MI (US); Ryan Skaff, Farmington Hills, MI (US); Johannes Geir Kristinsson, Ann Arbor, MI (US)

(72) Inventors: Qing Wang, Canton, MI (US); Hai Yu, Canton, MI (US); William Paul Perkins, Dearborn, MI (US); Anthony Mark Phillips, Northville, MI (US); Ryan Skaff, Farmington Hills, MI (US); Johannes Geir Kristinsson, Ann Arbor, MI (US)

(73) Assignee: FORD GLOBAL TECHNOLOGIES, LLC, Dearborn, MI (US)

(21) Appl. No.: 13/234,391

(22) Filed: Sep. 16, 2011

(51) Int. Cl. G06F 19/00

(52) U.S. Cl. 701/1; 180/65.21

(57) ABSTRACT

A method to control a vehicle includes assigning a predicted driving pattern to a predicted path for the vehicle, and providing a range for the vehicle using the predicted energy efficiency and an amount of energy available to the vehicle. The predicted driving pattern has an associated predicted energy efficiency. A vehicle includes a propulsion device coupled to wheels of the vehicle via a transmission, and a controller electronically coupled to the propulsion device. The controller is configured to: (i) assign a predicted driving pattern to a predicted path for the vehicle, the predicted driving pattern having a predicted energy efficiency, and (ii) provide a range for the vehicle using the predicted energy efficiency and an amount of energy available to the vehicle.

### TECHNICAL FIELD

The disclosure relates to a method of control to determine or estimate a vehicle range for a vehicle.

### BACKGROUND

Vehicles contain a certain amount of energy, in the form of chemical fuel, electrical power, or the like, which allows them to travel a certain distance, and may need to be refilled periodically. The distance that a vehicle can travel using on-board energy is referred to as the vehicle range. The projected vehicle range provides information for a user for trip planning, minimizing driving cost, evaluating vehicle performance and performing maintenance. The feasible range from the remaining energy in a motor vehicle is normally referred to as Distance to Empty (DTE), which is tied to the energy conversion efficiency of the vehicle.

A DTE or the vehicle range may be provided for any type of vehicle including conventional vehicles, electric vehicles, hybrid vehicles, plug-in hybrid vehicles, fuel cell vehicles, pneumatic vehicles, and the like.

### SUMMARY

In one embodiment, a method to control a vehicle assigns a predicted driving pattern to a predicted path for the vehicle. The predicted driving pattern has an associated predicted energy efficiency. The method also provides a range for the vehicle using the predicted energy efficiency and an amount of energy available to the vehicle.

In another embodiment, a method to control a vehicle provides a vehicle range using an energy efficiency corresponding to a driving pattern of the vehicle and an amount of energy available to the vehicle. The driving pattern is determined using a driving pattern identification method.

In yet another embodiment, a vehicle is provided with a propulsion device coupled to wheels of the vehicle via a transmission, and a controller electronically coupled to the propulsion device. The controller is configured to: (i) assign a predicted driving pattern to a predicted path for the vehicle, the predicted driving pattern having a predicted energy efficiency, and (ii) provide a range for the vehicle using the predicted energy efficiency and an amount of energy available to the vehicle.

### BRIEF DESCRIPTION OF THE DRAWINGS

FIG. 1 is a schematic representation of a hybrid electric vehicle powertrain capable of embodying the invention;

FIG. 2 is a diagram of the power flow paths for the components of the powertrain shown in FIG. 1;

FIG. 3 is an overview schematic of a method to estimate vehicle range;

FIGS. 4A and 4B are a schematic of a method to estimate vehicle range;

FIG. 5 is a schematic of a method for providing energy efficiencies;

FIG. 6 is a schematic of a method of calculating distance to empty;

FIG. 7 is a plot of vehicle range estimation when future driving information is unknown;

FIG. 8 is a plot of vehicle range estimation when future driving information is known; and

FIG. 9 is another plot of vehicle range estimation when future driving information is known.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Providing an accurate DTE for a vehicle may be difficult because vehicle range projection is connected to future driving uncertainties or unanticipated environmental conditions. In order to calculate a theoretical DTE for the vehicle, knowledge of the future vehicle cycles (speed profile and road conditions) is needed because the vehicle energy conversion efficiency is dynamically dependent on the operating conditions which are dominated by driving cycles. Although it is desirable to acquire the accurate speed profile and road conditions of the scheduled vehicle journeys, it is unfeasible, and so the range needs to be estimated using a pattern prediction method to provide a DTE for a vehicle.

A Hybrid Electric Vehicle (HEV) structure is used in the figures and to describe the various embodiments below; however, it is contemplated that the various embodiments may be used with vehicles having other propulsion devices or combinations of propulsion devices as is known in the art. Hybrid Electric Vehicles (HEVs) typically have power supplied by a battery powered electric motor, an engine, or a combination thereof. Some HEVs have a plug-in feature which allows the battery to be connected to an external power source for recharging, and are called Plug-in HEVs (PHEVs). Electric-only mode (EV mode) in HEVs and PHEVs allows the vehicle to operate using the electric motor alone, while not using the engine. Operation in EV mode may enhance the ride comfort by providing lower noise and better driveability of the vehicle, e.g., smoother electric operation, lower noise, vibration, and harshness (NVH), and faster vehicle response. Operation in EV mode also benefits the environment with zero emissions from the vehicle during this period of operation.

Vehicles may have two or more propulsion devices, such as a first propulsion device and a second propulsion device. For example, the vehicle may have an engine and an electric motor, a fuel cell and an electric motor, or other combinations of propulsion devices as are known in the art. The engine may be a compression or spark ignition internal combustion engine, or an external combustion engine, and the use of various fuels is contemplated. In one example, the vehicle is a hybrid vehicle (HEV), and additionally may have the ability to connect to an external electric grid, such as in a plug-in electric hybrid vehicle (PHEV).

A plug-in Hybrid Electric Vehicle (PHEV) involves an extension of existing Hybrid Electric Vehicle (HEV) technology, in which an internal combustion engine is supplemented by an electric battery pack and at least one electric machine to further gain increased mileage and reduced vehicle emissions. A PHEV uses a larger capacity battery pack than a standard hybrid vehicle, and it adds a capability to recharge the battery from an electric power grid, which supplies energy to an electrical outlet at a charging station. This further improves the overall vehicle system operating efficiency in an electric driving mode and in a hydrocarbon/electric blended driving mode.

Conventional HEVs buffer fuel energy and recover kinematic energy in electric form to achieve the overall vehicle system operating efficiency. Hydrocarbon fuel is the principal energy source. For PHEVs, an additional source of energy is the amount of electric energy stored in the battery from the grid after each battery charge event.

While most conventional HEVs are operated to maintain the battery state of charge (SOC) around a constant level, PHEVs use as much pre-saved battery electric (grid) energy as possible before the next battery charge event. The relatively low cost grid supplied electric energy is expected to be fully utilized for propulsion and other vehicle functions after each charge. After the battery SOC decreases to a low conservative level during a charge depleting event, the PHEV resumes operation as a conventional HEV in a so-called charge sustaining mode until the battery is re-charged.

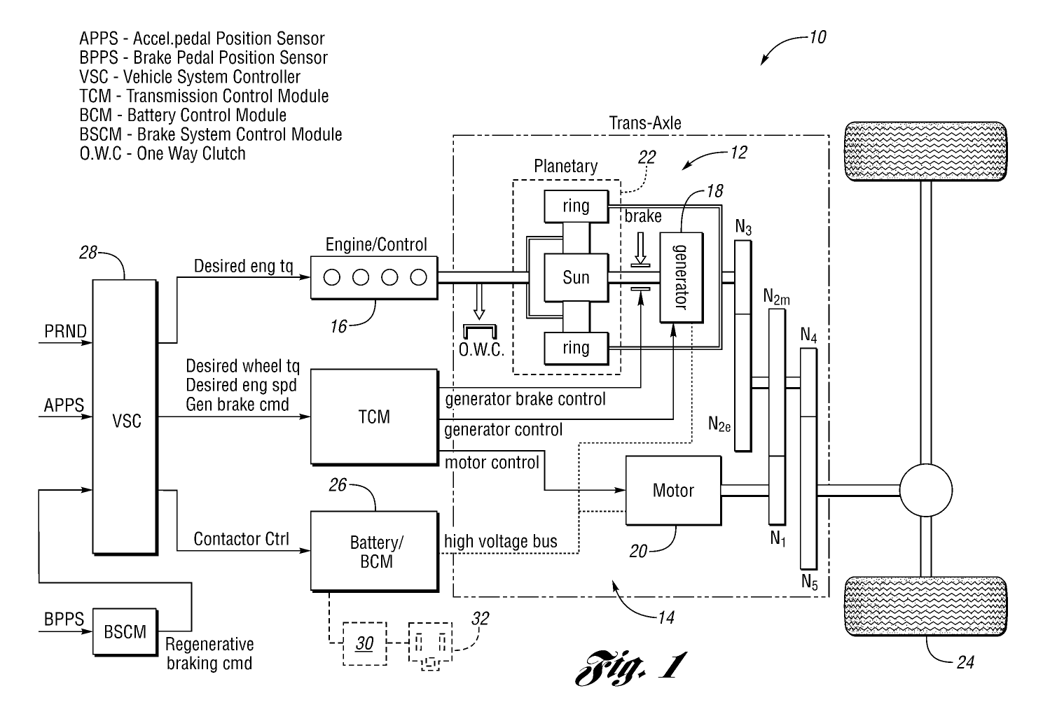

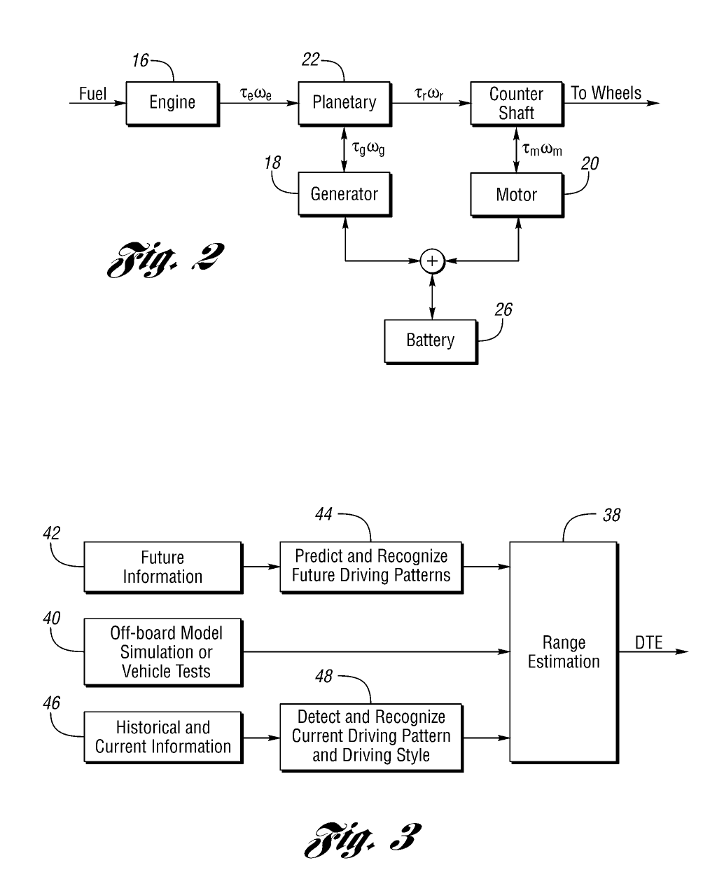

FIG. 1 illustrates an HEV 10 powertrain configuration and control system. A power split hybrid electric vehicle 10 may be a parallel hybrid electric vehicle. The HEV configuration as shown is for example purposes only and is not intended to be limiting as the present disclosure applies to vehicles of any suitable architecture, including HEVs and PHEVs.

In this powertrain configuration, there are two power sources 12, 14 that are connected to the driveline: 12) a combination of engine and generator subsystems using a planetary gear set to connect to each other, and 14) the electric drive system (motor, generator, and battery subsystems). The battery subsystem is an energy storage system for the generator and the motor.

The changing generator speed will vary the engine output power split between an electrical path and a mechanical path. In addition, the control of engine speed results in a generator torque to react against the engine output torque. It is this generator reaction torque that conveys the engine output torque to the ring gear of the planetary gear set 22, and eventually to the wheels 24. This mode of operation is called “positive split”. It is noted that because of the kinematic properties of the planetary gear set 22, the generator 18 can possibly rotate in the same direction of its torque that reacts against the engine output torque. In this instance, the generator 18 inputs power (like the engine) to the planetary gear set to drive the vehicle 10. This operation mode is called “negative split”.

As in the case of the positive split mode, the generator torque resulting from the generator speed control during a negative split reacts to the engine output torque and conveys the engine output torque to the wheels 24. This combination of the generator 18, the motor 20 and the planetary gear set 22 is analogous to an electro-mechanical CVT. When the generator brake (shown in FIG. 1) is actuated (parallel mode operation), the sun gear is locked from rotating and the generator braking torque provides reaction torque to the engine output torque. In this mode of operation, all the engine output power is transmitted, with a fixed gear ratio, to the drivetrain through the mechanical path.

In a vehicle 10 with a power split powertrain system, unlike conventional vehicles, the engine 16 requires either the generator torque resulting from engine speed control or the generator brake torque to transmit its output power through both the electrical and mechanical paths (split modes) or through the all-mechanical path (parallel mode) to the drivetrain for forward motion.

During operation using the second power source 14, the electric motor 20 draws power from the battery 26 and provides propulsion independently of the engine 16 for forward and reverse motions. This operating mode is called “electric drive” or electric-only mode or EV mode. In addition, the generator 18 can draw power from the battery 26 and drive against a one-way clutch coupling on the engine output shaft to propel the vehicle 10 forward. The generator 18 alone can propel the vehicle 10 forward when necessary. This mode of operation is called generator drive mode.

The operation of this power split powertrain system, unlike conventional powertrain systems, integrates the two power sources 12, 14 to work together seamlessly to meet the driver's demand without exceeding the system's limits (such as battery limits) while optimizing the total powertrain system efficiency and performance. Coordination control between the two power sources is needed. As shown in FIG. 1, there is a hierarchical vehicle system controller (VSC) 28 that performs the coordination control in this power split powertrain system. Under normal powertrain conditions (no subsystems/components faulted), the VSC interprets the driver's demands (e.g. PRND and acceleration or deceleration demand), and then determines the wheel torque command based on the driver demand and powertrain limits. In addition, the VSC 28 determines when and how much torque each power source needs to provide in order to meet the driver's torque demand and to achieve the operating point (torque and speed) of the engine.

The battery 26 is additionally rechargeable in a PHEV vehicle 10 configuration (shown in phantom), using a receptacle 32 which is connected to the power grid or other outside electrical power source and is coupled to battery 26, possibly through a battery charger/converter 30.

The vehicle 10 may be operated in electric mode (EV mode), where the battery 26 provides all of the power to the electric motor 20 to operate the vehicle 10. In addition to the benefit of saving fuel, operation in EV mode may enhance the ride comfort through lower noise and better driveability, e.g., smoother electric operation, lower noise, vibration, and harshness (NVH), and faster response. Operation in EV mode also benefits the environment with zero emissions from the vehicle during this mode.

A method for use with the vehicle 10 uses pattern prediction from a driving pattern identification method and off-board simulations (or vehicle tests) to provide a DTE estimation for the vehicle. The driving pattern identification method uses an algorithm that detects and recognizes real-world driving conditions as one of a set of standard drive patterns, including for example, city, highway, urban, traffic, low emissions, etc. In one embodiment, the algorithm is based on machine learning using a neural network. In other embodiments, the algorithm is based on support vector machines, fuzzy logic, or the like.

Regarding the driving pattern identification method, it is known that fuel efficiency is connected to individual driving styles, roadway types, and traffic congestion levels. A set of standard drive patterns, called facility-specific cycles, have been developed to represent passenger car and light truck operations over a broad range of facilities and congestion levels in urban areas. (See, for instance, Sierra Research, 30 ‘SCF Improvement—Cycle Development’, Sierra Report No. SR2003-06-02 (2003).) Driving styles have been captured in these standard drive patterns as well. For example, for the same roadway type and traffic level, different drivers may lead to different drive patterns. An online driving pattern identification method that automatically detects real-world driving condition and driving style and recognizes it as one of the standard patterns has been developed. (See, for example, Jungme Park, ZhiHang Chen, Leonidas Kiliaris, Ming Kuang, Abul Masrur, Anthony Phillips, Yi L. Murphey, ‘Intelligent Vehicle Power Control based on Machine Learning of Optimal Control Parameters and Prediction of Road Type and Traffic Congestions’, IEEE Transactions on Vehicular Technology, 17 Jul. 2009, Volume 58, Issue 9.) This online driving pattern method is based on machine learning using a neural network and its accuracy has been proven by simulations.

The driving pattern identification method chooses sequences of ‘drive pattern’ as the most effective high-level representation of the traffic speed, road condition and driving style, as the basis to calculate the average energy efficiency for DTE calculation. By sequencing drive patterns for a future vehicle route, trip or path, the cost and uncertainties of acquiring the precise future speed profiles and road conditions. The path, trip, or route may be entered or indicated by a user, or may be provided using an electronic horizon, which computes a route probability based on roads near the vehicle, the direction or the vehicle, etc. For example, if a vehicle is on a highway, the electronic horizon will use a highway path and the distance to the next exit as future predicted information, and then switch to an unknown, unpredicted future.

In order to provide a DTE for the vehicle, the VSC 28 uses a driving pattern and driving style identification method and vehicle simulation models. The driving pattern and driving style identification method, such as described in co-pending U.S. patent application Ser. No. 13/160,907, entitled “A Method to Prioritize Electric-Only Operation (EV) for a Vehicle,” filed on Jun. 15, 2011, the disclosure of which is incorporated in its entirety by reference herein. The driving style and identification method automatically detects and recognizes real-world driving condition or driving aggressiveness as one of the standard patterns or driving styles.

High-fidelity vehicle simulation models represent the actual vehicle with built-in controllers. The simulation can compute the Vehicle Energy Efficiency (‘MPG’/‘Miles per Gallon’ for fueled vehicles or ‘Miles per kWh’ for electrical vehicles) under any driving pattern represented by typical driving cycles. The simulation results typically match or correlate to the actual vehicle test results.

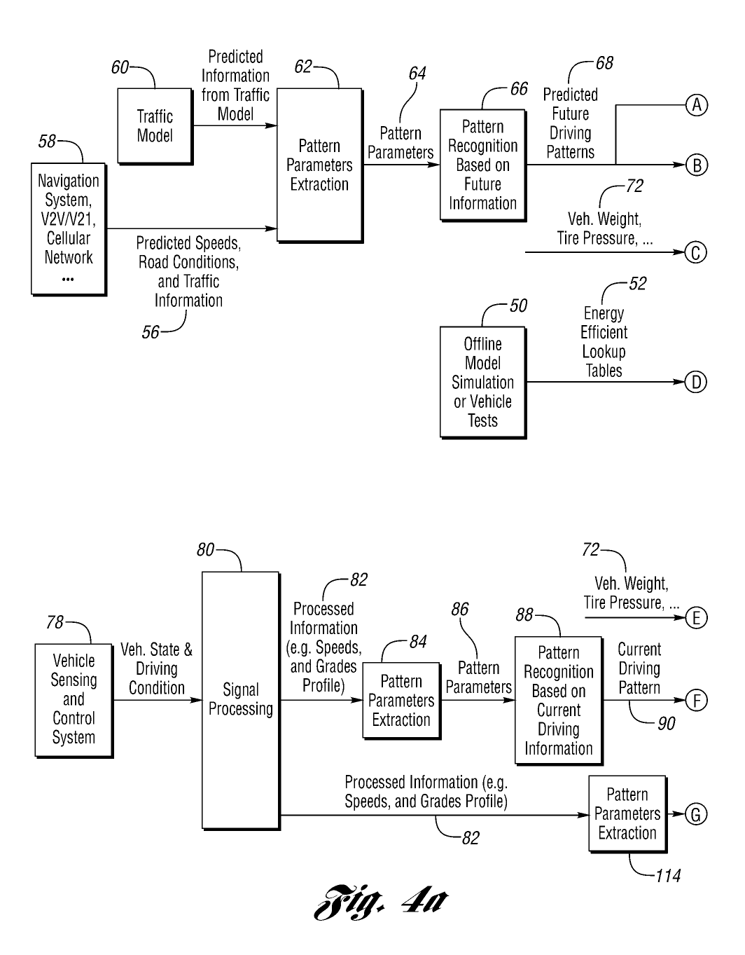

FIG. 3 illustrates a simplified schematic for the method of calculating a DTE or a vehicle range. Taking into consideration both predicted future and current driving patterns, the algorithm performs a calculation 38 with data fed from three main paths to estimate or provide a DTE for the vehicle. An off-board computation 40 of the ‘energy efficiency lookup tables’ is done in advance and loaded into the VSC 28 as a lookup table, or the like. Any future information available is determined at 42 and used in an on-board computation 44 to provide the average energy efficiency for the ‘predicted future driving patterns’ determined using a driving pattern identification method. Historical and current driving information is determined at 46 and provided to on-board computations 48 of the average energy efficiency for the ‘current driving pattern’, which is determined using a driving pattern identification method.

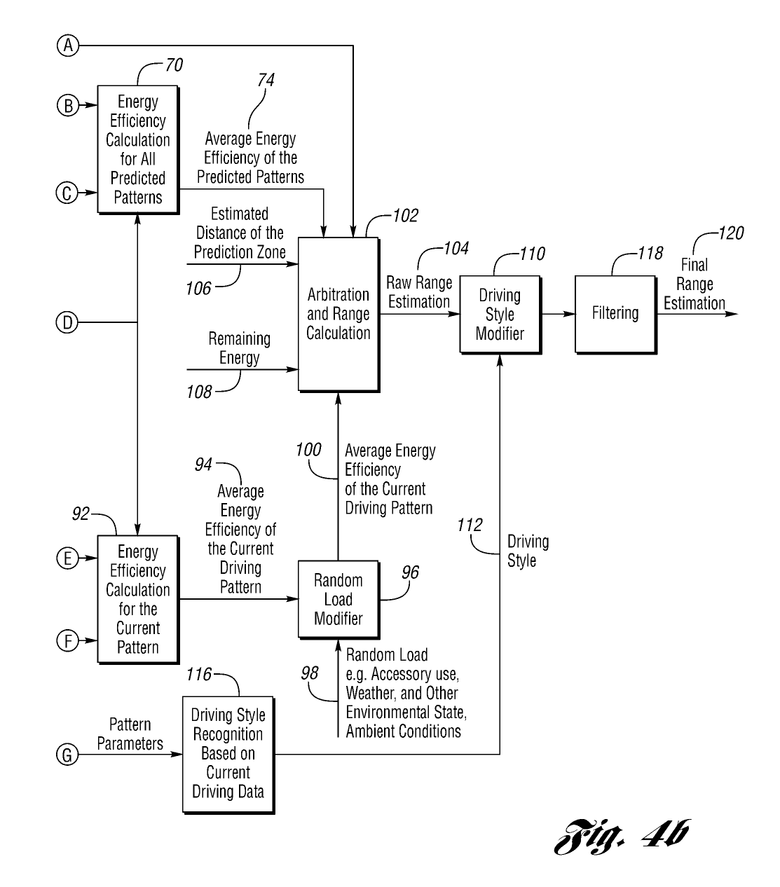

FIGS. 4A and 4B depict a more detailed schematic of the method of estimating and providing a DTE for the vehicle. Offline tests or simulations 50 provide energy efficiency lookup tables 52 which provide a driving pattern and an associated energy efficiency for each pattern. The tables are created offline, however, it is also contemplated that the tables could be created or updated while the vehicle operates, or on-line.

Future diving patterns and efficiencies are determined through sequence 54. Predicted speeds, road conditions, and/or traffic information 56 is provided by a navigation system, cellular network, and/or vehicle to vehicle network 58. A traffic model 60 may be present which provides additional predicted traffic considerations into the sequence 54. The predicted speeds of the vehicle and the other road and traffic conditions are provided to a pattern parameter extraction function 62, which in turn provides pattern parameters 64 to a pattern recognition function 66. The pattern recognition function 66 provides a predicted future driving pattern 68 for use in sequence 54.

An energy efficiency calculation 70 uses one or more predicted future driving patterns 68, the energy efficiency tables 52, and any data 72 available regarding the vehicle with respect to vehicle weight, tire pressure and the like which may affect efficiency. The calculation 70 then provides an average energy efficiency for the predicted patterns 74.

A sequence 76 is also provided to determine the present driving pattern and efficiency. The VSC 28 uses various vehicle sensors, inputs to a CAN bus, and the like at 78 and signal processes them at 80 to provide processed information 82 such as vehicle speeds, road grade, etc.

The processed information 82 is provided to a pattern parameter extraction function 84, which in turn provides pattern parameters 86 to a pattern recognition function 88. The pattern recognition function 88 provides a present or current driving pattern 90 for use in sequence 76.

An energy efficiency calculation 92 uses the current driving patterns 90, the energy efficiency tables 52, and any data 72 available regarding the vehicle with respect to vehicle weight, tire pressure and the like which may affect efficiency. The calculation 92 then provides an average energy efficiency for the current driving pattern 94.

A load modifier 96 uses the average efficiency of the current pattern 94 and any random load information 98 to provide an adjusted average efficiency of the current pattern 100. A random load may be weather conditions, the environmental state, an ambient condition, and/or a vehicle accessory is in use, such as an HVAC system. A random load modifier may also be present in sequence 54 (not shown) using weather forecasts and the like to adjust the predicted future energy efficiency.

The various inputs are arbitrated at 102 to calculate a raw range estimation 104. The arbitration considers the predicted future driving patterns 68, the average efficiency of the predicted future driving patterns 74, the average efficiency of the current driving pattern 100, an estimated distance of the predicted driving zone, path, or route 106, and the remaining energy 108 available to the vehicle.

The raw range estimate 104 may be modified at 110 for various driving styles 112. The driving style 112 is determined during sequence 76. The processed information 82 is provided to a pattern parameter extraction function 114, which provides pattern parameters to determine the driving style at 116 based on the current vehicle driving data.

Filtering of range occurs at 118. The filtering acts to remove hysteresis in the range and provides a smoothed fuel economy number and improves user perception. The final estimated DTE or range may then be provided to the user at 120 via a screen, human-machine interface (HMI), gauge, or the like.

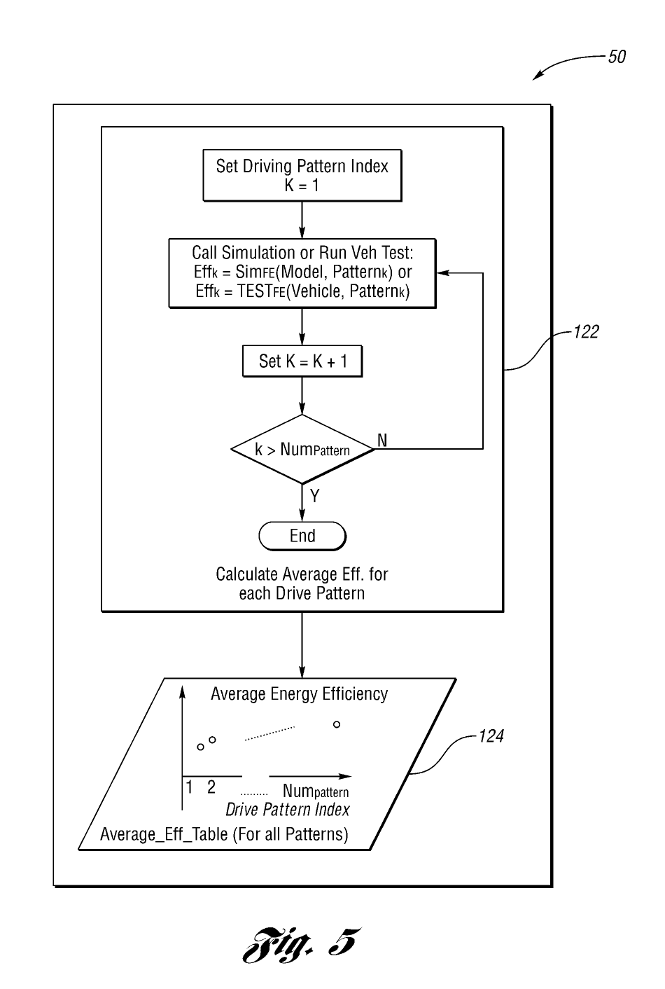

Referring now to FIG. 5, an off-board method to calculate a fuel economy table 50 is provided. The step 50 calculates and stores the average vehicle energy efficiency for each driving pattern by performing a model simulation or running an actual vehicle test. For example, the vehicle energy efficiency for driving Patternₖ may be obtained by either: Effₖ=Sim_{FE}(Model, Patternₖ) or Effₖ=TEST_{FE}(Vehicle, Patternₖ). The units of the ‘vehicle energy efficiency’ may be chosen as ‘distance/volume’ since people normally use ‘MPG’ or ‘MPkWh’ to indicate the vehicle energy efficiency.

The step 50 cycles through the range of potential driving patterns during the test or simulations phase at 122 to calculate an efficiency for each pattern. A table or correlation is then provided at 124 which includes the potential vehicle driving patterns and as associated energy efficiency for each.

The above simulations or vehicle tests 50 can be augmented by considering additional factors such as different vehicle weight, tire pressure, etc. These parameters may be used as additional inputs of the energy efficiency look-up tables. For example, an even more accurate vehicle energy efficiency for driving Patternₖ may be obtained by either: Effₖ=Sim_{FE}(Model, Patternₖ, Tire Pressure, Vehicle Weight, . . . ) or Effₖ=TEST_{FE}(Vehicle, Patternₖ, Tire Pressure, Vehicle Weight, . . . ).

The energy efficiency numbers generated above for the table 124 are needed for the on-board DTE calculation. The average vehicle energy efficiency should be consistent when simulated in the same drive pattern, but it varies with different driving patterns so that the DTE prediction can be updated upon changing current and future driving conditions to fit the customer's perception. Step 50 performs NumPattern (i.e., the total number of driving patterns) of iterations during 122 and the results are stored in CAL table 124 to be used on-board.

The pattern parameter extraction functions, shown as 62, 84 and 114 in FIG. 4, each represent a process to collect available pattern parameters, or to convert available information into typical driving pattern parameters. The function 62 extracts pattern parameters for predicting future driving patterns. Function 84 extracts pattern parameters for predicting the current driving pattern. Function 114 extracts pattern parameters for predicting a current driving style. Typical pattern parameters include: total distance of driving, average speed, maximum speed, standard deviation (SD) of acceleration, average acceleration, maximum acceleration, average deceleration, maximum deceleration, percentage of time within a specified speed interval, and percentage of time within a specified deceleration interval. Other parameters are also contemplated.

The parameters affect fuel usage and may be used to differentiate between driving patterns, and may be observed, calculated or approximated from multiple information sources. For example, most pattern parameters for the ‘current’ driving condition are extracted from the most-recent speed profile recorded on-board by the VSC 28, and processed into the desired format. Additionally with the availability of navigation systems, V2V/V2I (Vehicle to Vehicle/Vehicle to Infrastructure) and cellular/other networks, and traffic modeling, future information can be collected and processed into typical pattern parameters at 62.

Steps 70 and 92 lookup the corresponding average energy efficiency for the predicted driving patterns and current driving pattern, respectively. For example, if Patternₖ is recognized as the current driving pattern by 92, the ‘Average Vehicle Energy Efficiency’ of Patternₖ may be looked up as: Eff_Averageₖ=Average_Eff_Table(Patternₖ, Tire Pressure, Vehicle Weight . . . ).

Similarly if the future patterns are recognized as Patternₜ, Patternₜ₊ᵢ, . . . Pattern_{t+Tend}, step 70 lookups a set of ‘Average Vehicle Energy Efficiency’ numbers that correspond to the predicted patterns, where t is the time. T_{end} may be either the end of a trip or known future information, or may refer to partway through a trip.

The range or DTE arbitration and calculation 102 is depicted in greater detail in FIG. 6. The algorithm determines if predicted future patterns are available at 130. If predicted patterns are not available, the algorithm goes to step 132 and calculates the DTE using the current driving pattern energy efficiency and the amount of energy available to the vehicle.

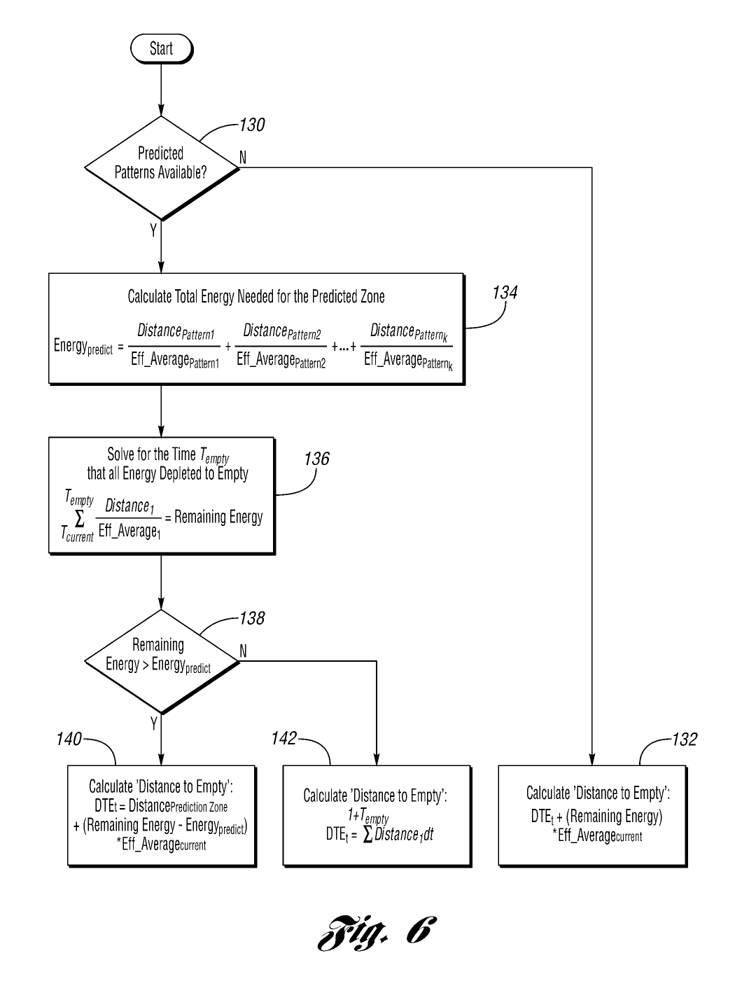

A scenario for step 132 is depicted in FIG. 7. If no future information is available or can be acquired, the future driving patterns are assumed to be the same as the ‘current driving pattern’, which is updated continuously as the on-board recognition algorithm collects the most recent driving data within a moving window. Alternatively, step 132 may assume another representative pattern explored from an individual driver's historical data. Once the assumed current driving pattern (e.g. Patternₖ) is determined, step 132 calculates ‘Distance to Empty’ assuming that Patternₖ sustains until the vehicle has run out of energy using DTEt=(Remaining Energy)*Eff_Averageₖ.

If predicted patterns are available, the algorithm goes to step 134 to calculate the total energy needed for the predicted zone(s) using the expected distance for each future driving pattern and the energy efficiency for that pattern as shown in FIG. 6. Once the total predicted energy needed has been calculated at 134, the algorithm calculates the amount of energy remaining at 136. The amount of energy remaining at 136 uses the time to empty, or the time that all of the energy available to the vehicle has been depleted such that the remaining energy is zero or another set floor value.

The algorithm 102 then compares the amount of energy needed to the amount of energy remaining at 138. If the amount of energy remaining is greater than the amount of energy needed, the algorithm proceeds to step 140. If the amount of energy remaining is less than then amount of energy needed, the algorithm proceeds to step 142.

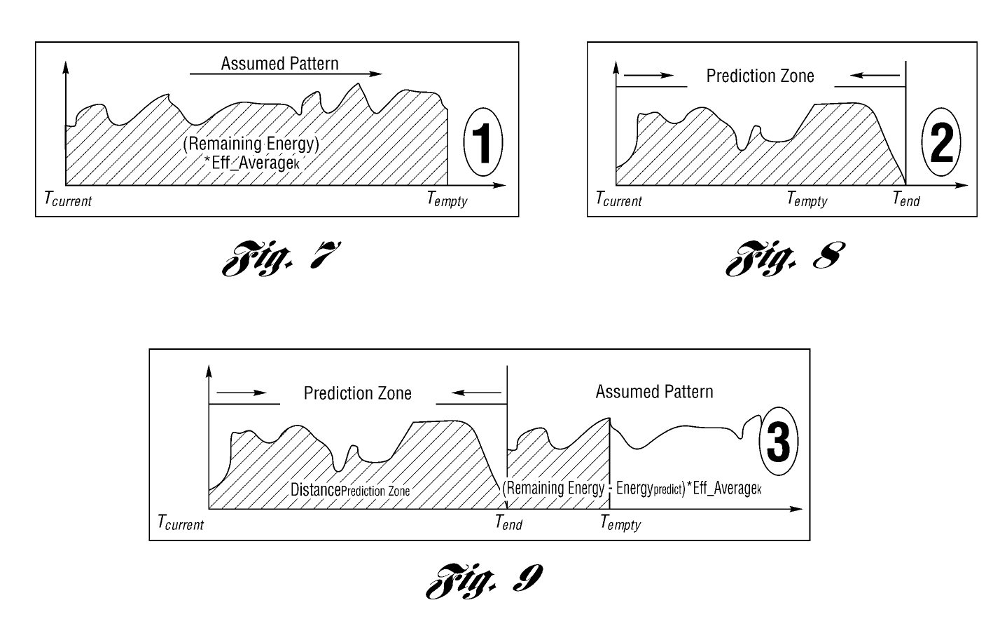

A scenario for step 142 is depicted in FIG. 8. The total energy needed is calculated for the distance or length of the prediction zone as:

$${Energy}_{predict} = \frac{{Distance}_{Pattern 1}}{{Eff\_Average}_{Pattern 1}} + \frac{{Distance}_{Pattern 2}}{{Eff\_Average}_{Pattern 2}} + … + \frac{{Distance}_{Pattern k}}{{Eff\_Average}_{Pattern k}} .$$

where Patternₖ is the last pattern of the prediction zone. The amount of energy available or the time to empty is also calculated as:

$${\sum }_{t = {T}_{current}}^{{T}_{empty}} \frac{{Distance}_{t}}{{Eff\_Average}_{t}} = Remaining Energy$$

and for this scenario, the time to empty, T_{empty}, occurs before T_{end}, the time to the end of the prediction zone.

The distance to empty (DTE) is then solved for by the algorithm by integrating the distances of the known patterns from the current time to the time to empty as:

$${DTE}_{t} = {\sum }_{t = {T}_{current}}^{{T}_{empty}} {Distance}_{t } d t$$

and this DTE may be provided to the user.

A scenario for step 142 is depicted in FIG. 9. Here, the future driving pattern is predicted from known future driving information, and the on-board energy (or remaining energy) is greater than the energy needed such that the vehicle can cover more than the entire distance of the prediction zone with the energy on-board. The patterns and the energy efficiencies are predicted within the prediction zone shown in FIG. 9. The driving pattern beyond the prediction zone is unknown, however, there is still energy available to the vehicle in this scenario.

The algorithm assumes the driving pattern beyond T_{end} to be the same as the ‘current driving pattern’ in order to calculate a DTE for the vehicle. For example, if the unknown future may be assumed to be Patternk, where Eff_Averageₖ=Average_Eff_Table (Patternₖ, Tire Pressure, Vehicle Weight . . . ), then the DTE for the scenario as shown in FIG. 9 may be calculated as:

DTEₜ=DistancePredictionZone+(Remaining Energy−Energypredict)*Eff_Averageₖ.

Alternatively, step 142 may assume another representative pattern explored from an individual driver's historical data.

Referring back to FIG. 4, modifier 96 adjusts the average energy efficiency of ‘current driving pattern’ by considering ‘random loads’ such as heating, ventilation, and air-conditioning (HVAC) use, stereo, other accessory use, weather, and other environmental states. The adjustments are done through a set of scaling factors.

For example, auxiliary loads increase energy consumption for a given driving pattern. The impact of the loads is drive-cycle dependent, so by estimating the impact of the loads on energy/fuel usage for each of the driving patterns, the impact on overall energy consumption may be estimated. The energy-impact of the auxiliary loads, such as belt-driven air conditioning, electrical loads, etc., can be estimated. Given a set of operating conditions such as environmental temperature, humidity, sun load, etc., the DTE algorithm may statistically estimate the probable auxiliary loads and modify the energy consumption accordingly by using look-up tables containing the relationships between auxiliary loads and energy consumption. Other factors such as an individual user's auxiliary load preferences taken from historical data (e.g., climate control and/or daytime driving lights) can also be used to calibrate the modifier 96.

The modifier 110 may also consider an individual's driving style 112 which impacts the range estimation for DTE. Based on the self-learning result of driving style in 116, a weighting factor may be applied in modifier 110 to adjust the raw estimation 104. Average efficiency of both the ‘predicted patterns’ and ‘current driving pattern’ may be modified by 110 because driving style is a characteristic of the user.

The scaling or weighting factors in modifier 96 and 110 are stored as calibrations that are tuned to match vehicle tests and model simulations.

Filtering 118 filters the ‘Distance to Empty’ for the display continuity to provide a final range estimation 120. The filtering function 118 smoothes out discontinuities of the DTE readout as the vehicle switches between roadway types. If no pattern change is detected the filtering remains inactive.

The method of calculating a DTE is applicable to all types of vehicles, including hybrid and battery electric vehicles. The method establishes vehicle energy efficiency by taking into account real-world driving conditions and driver styles from historical and predicted driving data.

Various input variables for the on-board calculation of DTE may be accessible through vehicle gauges, an on-board diagnostic interface, sensors, and the like and include: remaining energy, distance traveled, and average energy efficiency for the vehicle. A readout provides the DTE to a user.

It also should be noted that some inputs for the algorithm as shown in FIG. 4 are easy to measure or already exist for use by the VSC 28 in the vehicle. For example, ‘Distance Traveled’ may be calculated by taking the last distance reading and adding the incremental distance (calculated by multiplying the current speed with the time interval between readings). ‘Remaining Energy’ may be reported by the battery module or fuel gauge. In the case of multiple energy sources, the VSC 28 may calculate the total ‘equivalent energy’ for the DTE algorithm.

The methods and algorithms are independent of any particular programming language, operating system processor, or circuitry used to develop and/or implement the control logic illustrated. Likewise, depending upon the particular programming language and processing strategy, various functions may be performed in the sequence illustrated at substantially the same time or in a different sequence. The illustrated functions may be modified or in some cases omitted without departing from the spirit or scope of the present invention.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method to control a vehicle comprising:
assigning a predicted driving pattern to a predicted path for the vehicle, the predicted driving pattern having an associated predicted energy efficiency; and
providing a range for the vehicle using the predicted energy efficiency and an amount of energy available to the vehicle.

2. The method of claim 1 wherein the predicted path and the predicted driving pattern are based on future route information.

3. The method of claim 1 wherein the range is calculated to provide a distance to empty for the vehicle when the vehicle has insufficient energy to reach an end of the predicted path.

4. The method of claim 1 further comprising detecting a present driving pattern for the vehicle, the present driving pattern having an associated present energy efficiency, wherein the present energy efficiency is used in calculating the range.

5. The method of claim 4 further comprising assigning the present driving pattern to be the predicted driving pattern if the predicted path is unknown.

6. The method if claim 4 wherein the range is calculated using the current energy efficiency after the predicted path to provide a distance to empty if there is sufficient energy for the vehicle to reach an end of the predicted path.

7. The method of claim 4 further comprising determining the present driving pattern using a driving pattern identification method with a present driving condition.

8. The method of claim 1 further comprising displaying the range to a user of the vehicle.

9. The method of claim 1 further comprising determining the predicted driving pattern using a driving pattern identification method.

10. The method of claim 9 wherein the driving pattern identification method uses a predicted trip condition.

11. The method of claim 10 wherein the predicted trip condition is geographic information for a trip from a navigation system.

12. The method of claim 10 wherein the predicted trip condition is traffic data.

13. The method of claim 1 wherein the predicted driving pattern is determined using an electronic horizon.

14. The method of claim 1 further comprising using a database to reference a driving pattern and a corresponding energy efficiency, the database containing possible driving patterns for an operating state of the vehicle.

15. The method of claim 1 further comprising filtering the range when the driving pattern changes.

16. The method of claim 1 further comprising adjusting the range using a scaling factor if an accessory load exists.

17. The method of claim 1 further comprising adjusting the range using a scaling factor if a predetermined ambient condition exists.

18. A method to control a vehicle comprising providing a vehicle range using an energy efficiency corresponding to a driving pattern of the vehicle and an amount of energy available to the vehicle, the driving pattern determined using a driving pattern identification method.

20. A vehicle comprising:
a propulsion device coupled to wheels of the vehicle via a transmission; and
a controller electronically coupled to the propulsion device wherein the controller is configured to: (i) assign a predicted driving pattern to a predicted path for the vehicle, the predicted driving pattern having a predicted energy efficiency, and (ii) provide a range for the vehicle using the predicted energy efficiency and an amount of energy available to the vehicle.
